(19) United States
(12) Patent Application Publication
(10) Pub. No.: US 2012/0121888 A1
(43) Pub. Date: May 17, 2012

(54) THERMALLY INSULATING PRIMER PAINT FILLED WITH MICROSPHERES

(75) Inventors: James William Klett, Knoxville, TN (US); Nicholas A. Lowden, Oak Ridge, TN (US); Claudia Alexandra Walls, Oliver Springs, TN (US)

(73) Assignee: UT-Battelle, LLC, Oak Ridge, TN (US)

(21) Appl. No.: 12/945,413

(22) Filed: Nov. 12, 2010

(51) Int. Cl. B32B 5/16; B05D 3/02; C09D 5/00

(52) U.S. Cl. 428/323; 252/62; 427/372.2

(57) ABSTRACT

A thermally insulating paint composition including carbon microspheres having an average diameter in the range of 1 to 100 μm. The paint composition including the carbon microspheres can be applied as a primer coating to substrates such a metal, and can be covered with a finish coat of a second paint. The paint system including the microsphere-filled primer can lower interior temperatures when applied to vehicles or structures.

### GOVERNMENT RIGHTS

This invention was made with government support under Contract No. DE-AC05-00OR22725 awarded by the U.S. Department of Energy. The government has certain rights in the invention.

### FIELD OF THE INVENTION

The present invention relates to thermally insulating paint compositions.

### BACKGROUND OF THE INVENTION

Ceramic-based additives are available for paints in an attempt to impart thermal insulation properties to the paint. However, paints with insulators are often not effective due to a low R value of the structures, such as buildings, that are typically painted. As such, there exists a need for improved insulating paints, and/or new uses of thermally insulating paints.

### SUMMARY OF THE INVENTION

According to preferred embodiments of the invention, a thermally insulating paint composition is desired. The paint composition can be used to impart an insulation layer to various material surfaces. The paint composition can be applied as a primer coating to bare or painted surfaces, and have a finish coat of paint applied thereon. The paint compositions of this invention are particularly well suited for application to metal substrates, such as in vehicles, structures, or containers.

The thermally insulating paint composition of this invention includes carbon microspheres with other typical paint components, such as a solvent and a binder. The carbon microspheres desirably have an average diameter in the range of 1 to 100 μm, and form 1 to 30 wt. % of the paint composition.

The paint compositions of this invention can be applied to surfaces to provide painted articles. In one embodiment, a substrate surface of a painted article includes a coating of carbon microsphere-containing primer paint adherently disposed on the substrate surface, and a coating of a finish paint disposed over the coating of the primer paint. The paint compositions can be applied by known and appropriate painting methods, whereby at least a portion of a substrate surface of the article is coated and allowed to dry and/or cure with a primer paint, followed by an application of an adherent coating of the finish paint to the dried and/or cured coating of the primer paint. The finish paint coating is then also dried and/or cured.

### BRIEF DESCRIPTION OF THE DRAWINGS

The above-mentioned and other features and objects of this invention will be better understood from the following detailed description taken in conjunction with the drawings wherein:

FIG. 1 is a substrate of an article coated with a paint composition according to one embodiment of this invention;

FIG. 2 is the substrate of FIG. 1, further coated with a top coating of a finish paint;

FIG. 3 is a graph of the external temperatures of the ammunition boxes described in the examples section;

FIG. 4 is a graph of the internal temperatures of the ammunition boxes described in the examples section;

FIG. 5 is a graph of inside surface temperatures of the coated armor plates described in the examples section;

FIG. 6 is a 3-D model to simulate a one foot cube of armor with primer and paint;

FIG. 7 is a cross Section of the 3-D model of FIG. 6; and

FIG. 8 is a graph of the simulated inside surface temperature of the simulated box of FIG. 6. Heat is simulated as a solar loading from the (1, 1, 1) normal angle.

### DETAILED DESCRIPTION OF THE INVENTION

The present invention includes a thermally insulating paint composition, articles including the paint composition, and a method for coating substrates with the paint composition. The paint composition of this invention is not limited to any particular paint component or formulation, or any particular substrate, but has been unexpectedly found to be particularly useful as a primer, such as for bare surfaces, and particularly for metal substrates. In one embodiment of this invention, the paint composition is a primer paint for use on metal vehicle components, such as body panels.

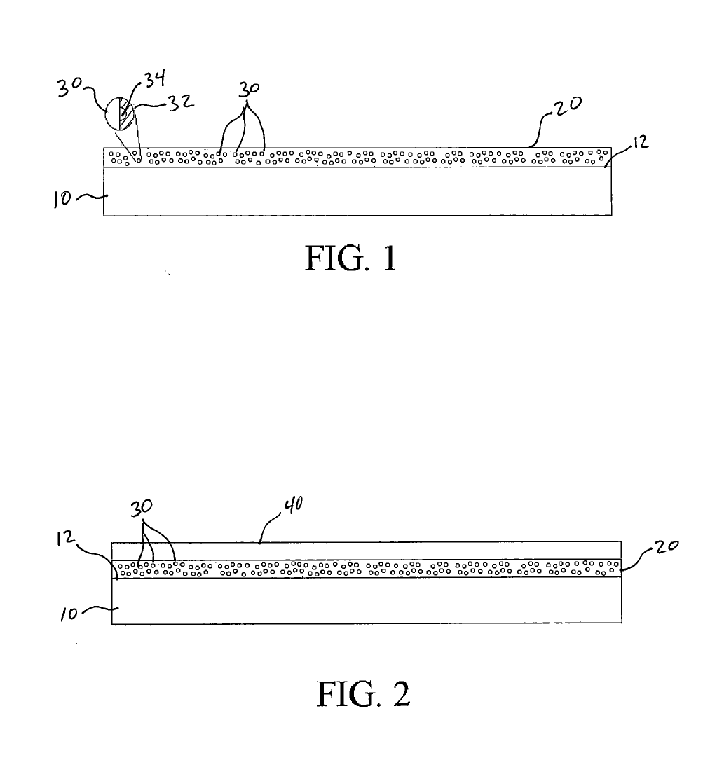

The thermally insulating paint composition of this invention includes hollow microspheres as an additive to impart thermally insulating properties. The microspheres are desirably dispersed throughout the liquid paint composition, and remain dispersed throughout a coating of the paint composition upon drying and/or curing. The microspheres generally have a spherical shape, although other and irregular shapes are also suitable for use, with a thin outer wall surrounding a hollow core area. FIG. 1 includes a generally representative hollow microsphere 30 including wall 32 surrounding hollow core 34. The hollow core 34 provides an air space that imparts thermal insulating properties to a filled paint composition.

In one embodiment of this invention, the paint composition includes carbon microspheres. Referring to FIG. 1, the outer wall 32 is formed of carbon, such as formed by known and available processes. One such forming process includes carbonization, i.e., a high temperature heat treatment, of polymer microspheres. Suitable polymer microspheres include polymer materials, without limitation, that retain the microspherical shape while heated. Phenolic resin microspheres, such as phenol formaldehyde, are examples of a preferred polymer microspheres for use in carbonization. The polymer microspheres are subjected to sufficient heat, for a sufficient time, in an inert atmosphere to covert the microspheres to carbon. One exemplary carbonization process occurs at temperatures greater than 1800° C. and in a nitrogen atmosphere. Higher carbonization temperatures or post carbonization firing to higher temperatures can be used with some species of microspheres to improve thermal and electrical conductivity, believed to be due to graphite alignment in the microstructures. In one embodiment of this invention, phenolic resin microspheres are carbonized between 1925° C. and 1975° C. Typically the phenolic resin microspheres lose more than 50% of both mass and volume upon carbonization, but will retain the hollow sphere shape.

Various sizes and shapes of carbon microspheres are available for use in the paint composition of this invention. In one embodiment, the microspheres added to the paint composition have a generally spherical shape with an average diameter in the range of 1 to 100 μm. Exemplary carbon microspheres suitable for use in the paint compositions of this invention are manufactured by BAM, Inc. (Knoxville, Tenn.).

The carbon microspheres can be added to various and alternative paint formulations to form the paint compositions of this invention. The paint compositions generally include a film-forming binder material in a solvent. The amount and type of binder and solvent can vary depending on need. The binder imparts adhesion and imparts properties such as finish, durability, flexibility, and toughness. Exemplary binders can include, without limitation, synthetic or natural resins such as acrylics, vinyl-acrylics, vinyl acetate/ethylene, polyurethanes, polyesters, melamine resins, or epoxy. Suitable solvents include, without limitation, water or organic solvents such as aliphatics, aromatics, alcohols, ketones, petroleum distillate, esters, and glycol ethers.

The paint compositions of this invention can also include pigments, fillers, or other additives, depending on need. Exemplary pigments include various clays, calcium carbonate, mica, silicas, talcs, engineered molecules, calcined clays, precipitated calcium carbonate, titanium dioxide, phthalo blue, red iron oxide, and many others. Fillers may be used to thicken the coating film or increase the volume of the paint composition. Exemplary fillers include inert materials such as diatomaceous earth, talc, lime, or clay. Other optional additives include, without limitation, stabilizers, emulsifiers, texturizers, adhesion promoters, UV stabilizers, and antimicrobials.

The carbon microspheres can be added to the paint composition during paint manufacturing, or implemented as an additive in commercially available paint formulations prior to painting. In one embodiment of this invention, the paint composition includes about 1 to about 30 weight percent (wt. %) carbon microspheres, preferably about 1 to about 15 wt. % carbon microspheres, more preferably about 5 to about 15 wt. % carbon microspheres. In one particularly preferred embodiment, the paint composition includes about 10 wt. % carbon microspheres. The paint composition of one embodiment of this invention desirably includes only microspheres formed of carbon, which have been unexpectedly found to provide beneficial results over other types of microspheres. However, the paint compositions can also optionally include additional types and sizes of hollow microspheres, such as ceramic or glass microspheres.

The invention further includes a painted article having a surface coated with the paint composition of this invention. As discussed above, the paint composition of this invention can include various paint formulations, depending on need. In one preferred embodiment of this invention, the paint composition including carbon microspheres is a primer paint composition. FIG. 1 illustrates a metal substrate 10, such as a vehicle body panel or storage container, although other materials such as wood or plastic can also be painted according to this invention. The substrate 10 has a surface 12 including a coating 20 of a paint composition of this invention, such as a primer paint composition. A plurality of carbon microspheres 30, such as described above, is dispersed through the coating 20. The inclusion of the carbon microspheres is desirably not noticeable to the naked eye, but desirably imparts a thermal insulation property to the coating 20. The air-filled hollow cores 34 of the microspheres 30 slow the transfer of heat energy through the coating 20 to the article substrate 10.

FIG. 2 illustrates the painted article of FIG. 1 with a further top coat 40 of a finish paint. The coating 20 including the microspheres 30 is a primer for the bare metal surface 12, and desirably both promotes adhesion of the finish paint 40 and provides a thermal insulation layer. The finish paint coating 40 can be any desired paint formulation, and can provide a decorative and/or functional purpose. In one embodiment of this invention, the finish paint coating 40 is formed from a light-reflecting paint which further adds to the heat-resistance of the substrate coating. The finish paint coating 40 can include hollow microspheres, but desirably is essentially free of microspheres.

The paint compositions of this invention can be applied by known and available methods, such as brush or spray coating. Referring to FIGS. 1 and 2, the primer paint is first applied to the surface 12 and dried and/or cured to adhere coating 20 to the surface 12. An adherent coat of the finish paint is then applied to the dried and/or cured coating of the primer paint. The finish paint is dried and/or cured to adhere the finish paint to the primer paint coating 20 as finish paint coating 40. Additional primer coats and/or finish paint coats can also be applied, depending on need and the particular paint formulation.

The present invention is described in further detail in connection with the following examples which illustrate or simulate various aspects involved in the practice of the invention. It is to be understood that the examples are included to assist in the understanding of this invention and are in no way limiting to the invention in its broad application. All changes that come within the spirit of the invention are desired to be protected and thus the invention is not to be construed as limited by these examples.

### EXAMPLES

A target microsphere weight percentage for testing was determined by separately mixing samples of paint with different concentrations of carbon microspheres and Bionic Bubbles. The paint used in these examples was primer paint used on BEARCAT vehicles, and obtained from Lenco Industries, Inc. (Pittsfield, Mass.). The Bionic Bubbles were microspheres available from Sphere Services, Inc. (Oak Ridge, Tenn.).

The primers were poured into separate trays and cured for 24 hours. Testing samples were cut from the cured primer films. Thermal testing as well as physical characterization indicated that 10% microspheres by weight was optimum for further testing. The 10% by weight sample had a high insulation value along with good primer flexibility and strength (not as brittle).

The primer paint composition including 10% carbon microspheres was tested against a control of the primer paint without any microspheres. Each sample was painted onto a metal ammunition box. Three thermocouples were attached to each ammunition box, one on the outside surface, one on the inside surface, and the other within the box for inside air temp. The painted ammunition boxes were placed under a heat lamp to simulate sunlight, and the temperatures were measured by the thermocouples.

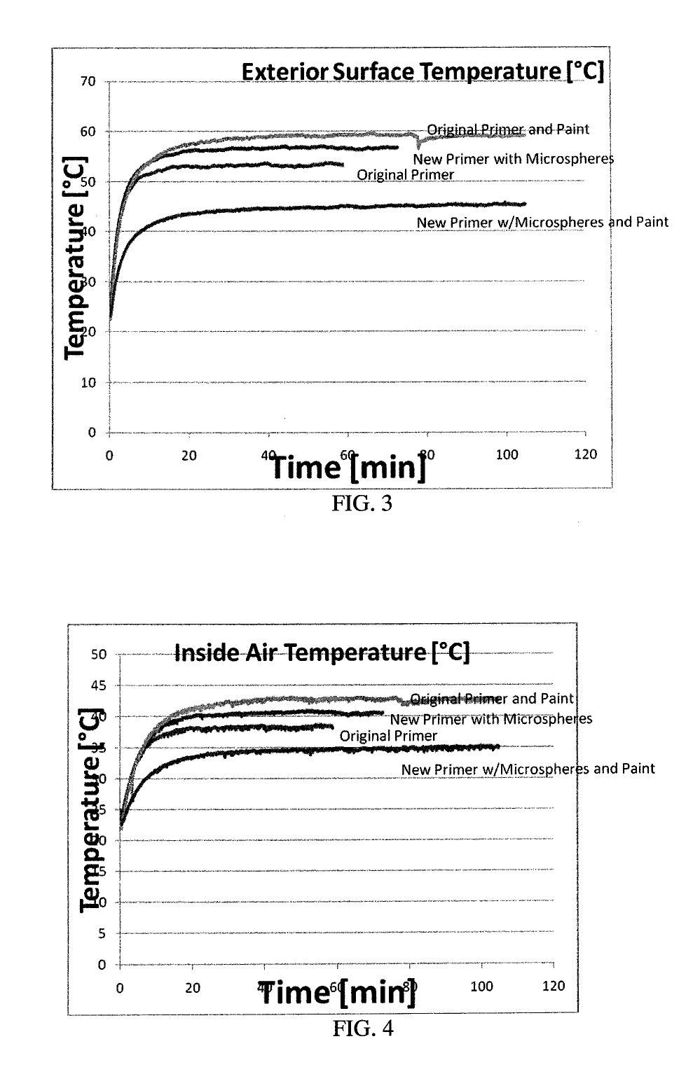

The primer with the carbon microspheres was found to have reduced the heat transfer more than the neat (raw) control primer. The surface of the box coated with the microsphere primer was significantly cooler to the touch than the box with the raw primer, but registered a higher temperature, both on the exterior surface as well as the interior air temperature. This is likely due to the higher emissivity of the microsphere filled primer (i.e., it absorbs more heat). It was found that the microspheres themselves have a high emmisivity, and thus absorptivity, and thus adding these to a paint will increased its emmisivity. FIGS. 3 and 4 illustrate the measured results. The reason that it feels cooler while registering a higher temperature is indicative of a material with a much lower thermal conductivity. The lower the conductivity, the slower the material can release the energy to the hand touching it, thus it feels cooler.

The primed ammunition boxes were then painted with a topcoat of black LENCO BEARCAT Paint, including no microspheres, and the testing was repeated. After putting a coat of the black bearcat paint onto the surface of the two boxes, the box with the neat control primer heated up significantly. As can be seen in FIG. 4, the black paint resulted in significant increase in heat added to the box as the interior air temperature of the original primer and paint resulted in an interior air temperature of nearly 42° C. (107° F.). The box with the primer having 10 wt. % microspheres had an interior air temperature of nearly 35° C. (95° F.), or a significant 7° C. (12° F.) difference. The ambient temperature in the room was 25° C. (77° F.), and the temperature rise of the interior air in the control was 17° C. (30.6° F.), while the new primer with microspheres resulted in a temperature rise of only 10° C. (18° F.). This is a drop in heat load to the interior of the vehicle of nearly 41%. This should allow the air conditioner of a vehicle painted with the paint composition of this invention to perform more efficiently and cool the inside of the cab more effectively.

The exterior of the box with the microsphere primer and paint was noticeably cooler (see FIG. 3). The exterior temperature dropped nearly 15° C. (or 27° F.). Thus the outside of a vehicle will be expected to be cooler with the paint composition of this invention than with the control paint, thus emitting a much lower thermal signature.

The paint systems were then tested on 0.5 inch armor plates. One armor plate was spray coated with the control primer and the other armor plate was spray coated with the primer including the 10% microspheres. Each armor plate was then top coated with the same finish paint as the ammunition boxes.

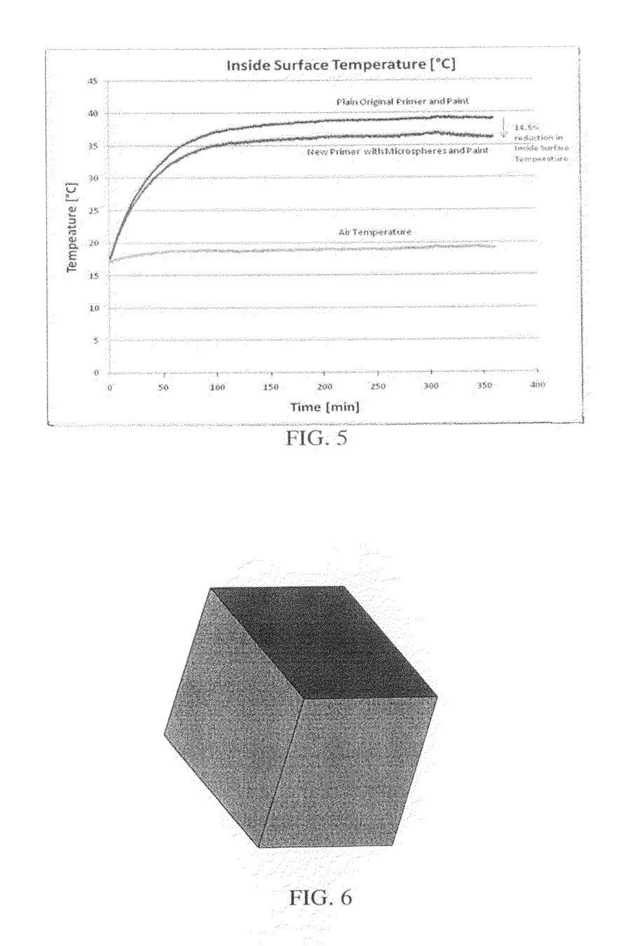

The two plates were placed adjacent, and eighteen inches from a 500 W halogen bulb lamp. The inside surface (i.e., the side opposite the lamp) temperature was measured over time, with the results shown in FIG. 5. The plate including the microsphere-filled primer demonstrated a 14.5% drop in heat flux through the plate.

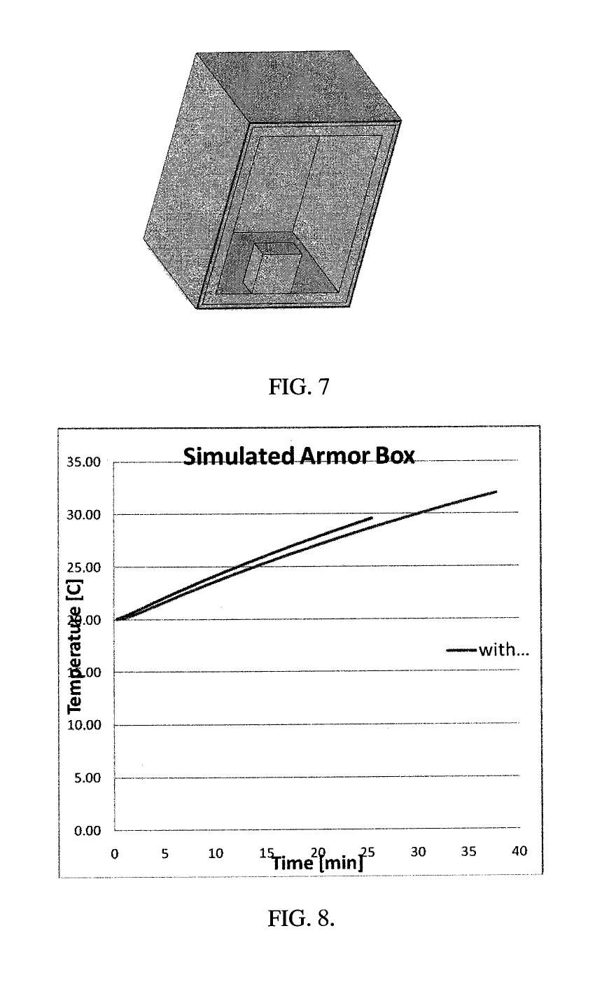

Computer simulations were executed to simulate the effects of the primer on actual armor plate. A box the same size as the ammunition boxes was modeled in 3-D software (Solidworks), as shown in FIGS. 6 and 7. The armor thickness of the box was set at 0.5 inch, and the thickness of the primer was set at 0.1 inch thick (similar to that found with the actual painted samples). Solar radiation was simulated to hit the box on three sides (thus maximizing the amount of solar radiation on the surfaces). The amount of solar radiation was estimated to be nearly 1100 W/m2 (determined from several areas of the desert in the southwest United States). The thermal conductivity of the primer was set at 0.7 W/mK, and that of the primer with microspheres at 0.2 W/mK.

The simulation was performed and the temperature of the inside surface of the box was calculated as well as the inside fluid temperature of the air. The inside fluid temperature is plotted in FIG. 8. As can be seen in FIG. 8, this model predicted a 10% reduction in temperature of the inside surface (similar to that of the tested armor plates). In addition, the inside fluid temperature experienced about a 10% reduction in temperature as well.

This demonstrates that the coated primer/paint combination of this invention will reduce the heat duty on the personnel in the cabin of a vehicle.

It is believed that the thicker the armor plate, the less effective in overall heat reduction the coating will be, as it is a less percentage of the overall thermal resistance to heat flow. In other words, the armor plate contributes to the insulation, and the more of it, the less the primer system may be effective. However, further modeling showed that the thickness of the primer can play a significant role in reducing the heat transfer. In another model, the thickness of the primer was quadrupled, and the heat flux had a significant drop of nearly 40% on the 0.5 inch thick armor. It is anticipated that the primer may not always be able to be thickened to this extent, due to reliability, chipping issues, and durability of the coating. However, the inside surface can be coated with a thick layer of polymer material, such as available from Rhino Linings Corporation, with microspheres imbedded in it (this has been demonstrated to be effective and still be very durable).

Thus the invention provides a paint composition for use in providing thermally insulating coatings to articles. The paint compositions of this invention are particularly useful for metal surfaces, such as, without limitation, in land, sea, and air vehicles, storage containers, and metal structures and roofs. The paint compositions have been demonstrated to be useful as primer layers in a primer/paint system.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A thermally insulating paint composition comprising a solvent, a binder, and carbon microspheres having an average diameter in the range of 1 to 100 μm.

2. The paint composition of claim 1 wherein the paint composition is a primer paint composition for coating bare metal.

3. The paint composition of claim 1 further comprising 1 to 30 wt. % carbon microspheres.

4. The paint composition of claim 3 further comprising 1 to 15 wt. % carbon microspheres.

5. The paint composition of claim 3 further comprising about 10 wt. % carbon microspheres.

6. A painted article comprising:
a substrate surface;
a coating of primer paint adherently disposed on the substrate surface, the primer paint including carbon microspheres having an average size in the range of 2 to 100 μm; and
a coating of a finish paint disposed over the coating of the primer paint.

7. The painted article of claim 6 wherein the substrate is metal.

8. The painted article of claim 6 wherein the painted article is a vehicle.

9. The painted article of claim 6 wherein the coating includes 1 to 30 wt. % carbon microspheres.

10. The painted article of claim 9 wherein the coating includes 5 to 15 wt. % carbon microspheres.

11. The painted article of claim 10 wherein the coating includes about 10 wt. % carbon microspheres.

12. The painted article of claim 6 wherein the finish paint comprises a light-reflecting paint.

13. The painted article of claim 12 wherein the finish paint is essentially free of carbon microspheres.

14. A method of applying a thermally insulating coating to an article comprising the steps of:
a. coating at least a portion of a substrate surface of the article with a primer paint, the primer paint including carbon microspheres having an average size in the range of 2 to 100 μm;
b. drying and/or curing the coating of the primer paint;
c. applying an adherent coating of a finish paint to the dried and/or cured coating of the primer paint; and
d. drying and/or curing the adherent coating of the finish paint.

15. The method of claim 14 wherein the substrate is metal.

16. The method of claim 14 wherein the primer paint includes 1 to 30 wt. % carbon microspheres.

17. The method of claim 16 wherein the primer paint includes 5 to 15 wt. % carbon microspheres.

18. The method of claim 16 wherein the primer paint includes about 10 wt. % carbon microspheres.

19. The method of claim 14 wherein the finish paint comprises a light-reflecting paint.

20. The method of claim 14 wherein the finish paint is essentially free of carbon microspheres.
